(19) United States
(12) Patent Application Publication
(10) Pub. No.: US 2012/0198001 A1
(43) Pub. Date: Aug. 2, 2012

(54) METHOD TO SHOW/HIDE E-MAIL MESSAGES BY A SENDER OR GROUP OF SENDERS WITHIN AN E-MAIL THREAD

(75) Inventor: Lisa Seacat DeLuca, San Francisco, CA (US)

(73) Assignee: International Business Machines Corporation, Armonk, NY (US)

(21) Appl. No.: 13/015,221

(22) Filed: Jan. 27, 2011

(51) Int. Cl. G06F 15/16

(52) U.S. Cl. 709/206

(57) ABSTRACT

An embodiment of the invention includes a method for displaying electronic messages. The electronic messages are displayed to a user in a conversation thread. The conversation thread only includes a first message and at least one reply message, wherein the reply message including a direct reply to the first message and/or an indirect reply to the first message. A request is received from the user to display select messages from the conversation thread. The request includes a request to display only messages from the conversation thread sent from a select sender or a request to display only messages from the conversation thread not sent from the select sender. Only the select messages from the conversation thread are displayed to the user based on the received request.

### BACKGROUND

The present invention is in the field of methods, systems, and computer program products to show and/or hide e-mail messages by a sender or group of senders within an e-mail thread.

Modern technological advances have made the Internet more accessible at faster connection speeds. As a result, electronic mail (e-mail) has become an increasingly popular means for people to communicate with their friends, family, and colleagues. In addition to the ease of drafting and delivering an electronic message, e-mail communication is relatively inexpensive and is accessible on mobile telephones and areas serviced by wireless Internet. Furthermore, electronic messages are delivered to recipients in an extremely short period of time, especially when compared to mail and ground couriers.

### SUMMARY OF THE INVENTION

An embodiment of the invention includes methods, systems, and computer program products for displaying electronic messages. The electronic messages are displayed to a user in a conversation thread. The conversation thread only includes a first message and at least one reply message, wherein the reply message including a direct reply to the first message and/or an indirect reply to the first message. A request is received from the user to display select messages from the conversation thread. The request includes a request to display only messages from the conversation thread sent from a select sender or a request to display only messages from the conversation thread not sent from the select sender. Only the select messages from the conversation thread are displayed to the user based on the received request. The select messages include only messages from the conversation thread sent from the select sender or only messages from the conversation thread not sent from the select sender.

In another embodiment of the invention, a method of displaying electronic messages includes displaying the electronic messages to a user in a conversation thread and automatically displaying options to the user in response to the user selecting a single message in the conversation thread. The options include an option to display only messages sent from a sender of the single message, and an option to display only messages not sent from the sender of the single message. A selected option is received from the user; and, an updated conversation thread is displayed to the user based on the selected option.

In yet another embodiment of the invention, a method of displaying electronic messages includes displaying the electronic messages to a user in a conversation thread and receiving input from the user, wherein the input includes predefined groups of senders. A request is received from the user to display select messages from the conversation thread. The request including a request to display only messages sent from senders in a predefined group or a request to display only messages not sent from the senders in the predefined group. Only the select messages are displayed to the user based on the received request. The select messages including only messages sent from the senders in the predefined group, or only messages not sent from the senders in the predefined group.

Another embodiment of the invention provides a system for displaying electronic messages. The system includes a display for displaying the electronic messages to a user in a conversation thread and for displaying options to the user in response to the user selecting a single message in the conversation thread. The options include an option to display only messages sent from a sender of the single message, and an option to display only messages not sent from the sender of the single message. The system further includes an interface for receiving a selected option from the user. A processor is included for sending an updated conversation thread to the display, wherein the updated conversation thread is based on the selected option.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method to show and hide e-mail messages from an individual or group of individuals according to an embodiment of the invention;

FIG. 2 is a flow diagram illustrating a method of displaying electronic messages according to an embodiment of the invention;

FIG. 3 illustrates a system for displaying electronic messages according to an embodiment of the invention; and

FIG. 4 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a system and method to show or hide e-mail responses from an individual or group of individuals. More specifically, the document object model (DOM) specifies how objects in a web page (e.g., text, images, headers, and links) are displayed. HyperText Markup Language (HTML) relies on the DOM to change the appearance of web pages after they have been downloaded to a browser. At least one embodiment of the invention supplies a style attribute to the e-mail DOM element for hiding and showing purposes, e.g., <div style=“display:none”>.

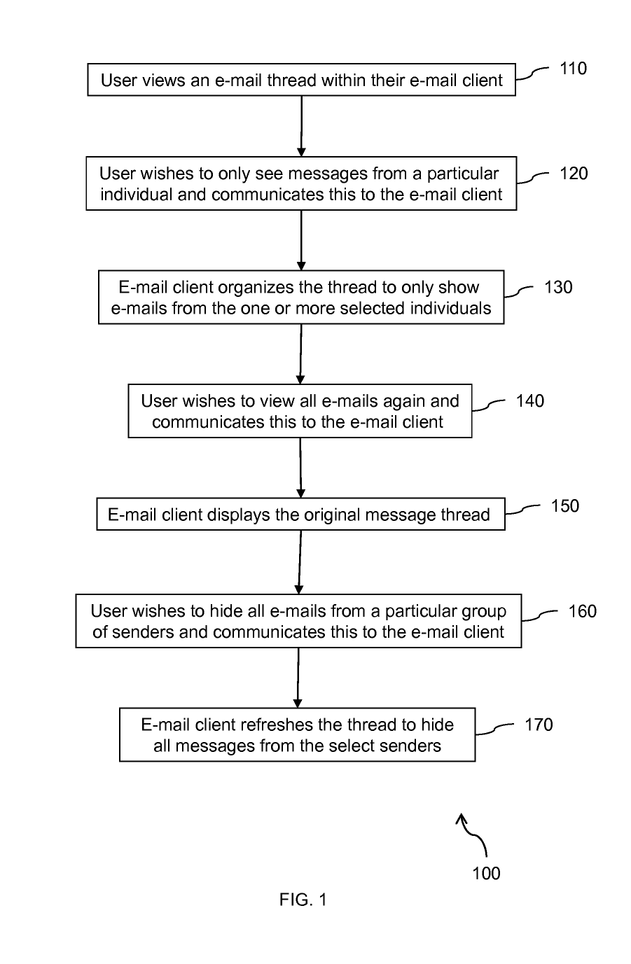

FIG. 1 is a flow diagram illustrating a method 100 to show and hide e-mail messages from an individual or group of individuals according to an embodiment of the invention. A user views an e-mail thread within their e-mail client 110. As used herein, the terms “thread” and “conversation thread” refer to a subset of electronic messages from an inbox. Typically, a thread is a combination of electronic messages within a larger inbox that have the same or similar subject across the messages. For example, a thread is series of electronic messages between two or more senders that have been sent as replies to each other. A new thread is started by sending a message to one or more recipients that is not a reply to an earlier message. The thread may be sorted and/or filtered to create an updated thread, which may include a subset of senders from the original thread.

The user wishes to only see messages from a particular individual and communicates this to the e-mail client 120. In one embodiment, the user hovers the cursor over the e-mail address of the individual and clicks the right mouse button. The e-mail client presents options to the user, including: “View Only E-mails from this Sender” and “Hide E-mails from this Sender”. In another embodiment, the options are automatically presented to the user without the user having to click a mouse button. The user selects “View Only E-mails from this Sender”. In yet another embodiment, the user selects an option via the keyboard. For example, the user enters “CTRL-V”, “CTRL-SHIFT-V”, or a function key to select “View Only E-mails from this Sender”.

The e-mail client organizes the thread to only show e-mails from the one or more selected individuals 130. Specifically, the e-mail client uses style to hide messages from other senders, grays out other e-mail messages from other senders, and/or moves all messages from the selected individual to the top of the thread.

The user wishes to view all e-mails again and communicates this to the e-mail client 140. In response to a right mouse click anywhere on the screen, the e-mail client presents the user with the option “View All E-mails”. In another embodiment, this option is automatically presented to the user when the cursor is proximate the “Inbox” and/or “From” icons. In yet another embodiment, the user selects the option “View All E-mails” via the keyboard, e.g., “ALT-A”, “CTRL-SHIFT-A” or a function key. In still another embodiment, the selected option (e.g., “View Only E-mails from this Sender”) is displayed at the top of the thread to remind the user that the thread has been altered. The user is presented with the option “View All E-mails” when the user clicks or moves the cursor proximate the selected option displayed towards the top of the thread. The user's e-mail client displays the original message thread when the “View All E-mails” option is selected, e.g., e-mails sorted by date of receipt 150.

The user wishes to hide all e-mails from a particular group of senders within an e-mail thread and communicates this to the e-mail client 160. For example, the e-mail client presents the user with options when the cursor is positioned proximate a message from john.doe@us.ibm.com, including “View Only E-mails From @us.ibm.com” and “Hide E-mails From @us.ibm.com”. The user selects “Hide E-mails From @us.ibm.com” via the mouse. In another embodiment, an option is selected by the user via the keyboard, e.g., “CTRL-SHIFT-H”. The e-mail client refreshes the thread to hide all messages from senders from the @us.ibm.com domain 170.

In at least one embodiment of the invention, the user categorizes groups of senders. For example, the user adds 5 new senders to his contact list: Bob, Sue, Joe, Sally, and Molly. The user categorizes Bob and Sue into Group A, Joe into Group B, Sally into Group C, and does not place Molly into a defined group. When the cursor is positioned over a message from Sue, the client automatically recognizes that Sue is in Group A and presents the user with options, including: “View Only E-mails from Group A” and “Hide E-mails from Group A”. In another, the user renames the groups, e.g., “Work”, “Work Group”, “Softball”, “Church”.

In yet another embodiment, a contact list is imported to the e-mail client from the user's social networking website account. For example, the user's friend list is imported from the user's FACEBOOK® account. Thus, when the cursor is positioned next to a message from a FACEBOOK® friend of the user, the e-mail client presents the user with options, including: “View Only E-mails from FACEBOOK® friends” and “Hide E-mails from FACEBOOK® friends”.

In at least one embodiment, the user selects more than one Show/Hide option. For example, user positions the cursor on a message from jane.doe@us.ibm.com, who is in the user's Group D category. The user selects “View Only E-mails from @us.ibm.com” and “Hide E-mails from Group D”. Thus, the e-mail client refreshes the thread to include all e-mails from senders having the @us.ibm.com domain except for messages from senders in Group D, including jane.doe@us.ibm.com.

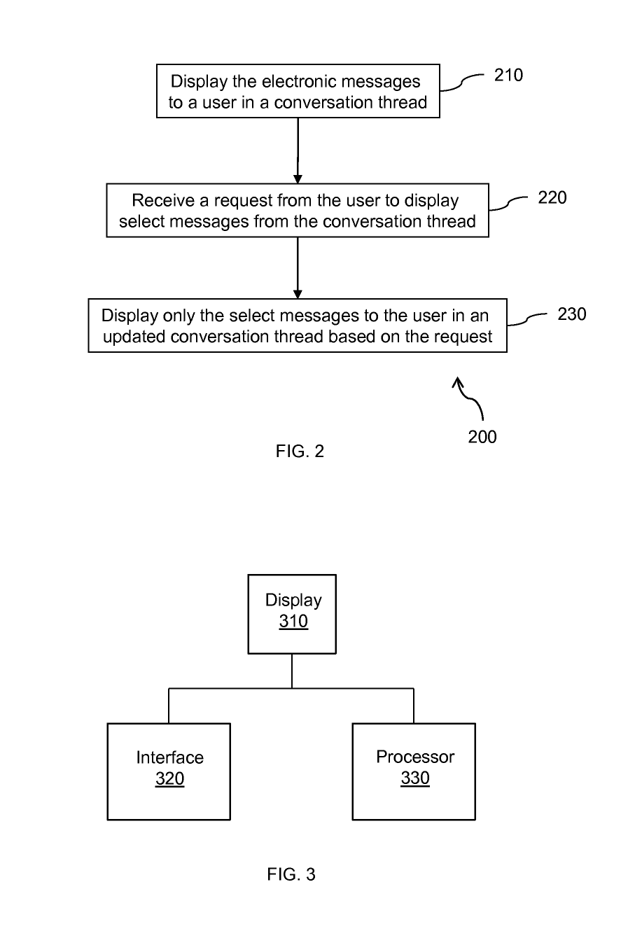

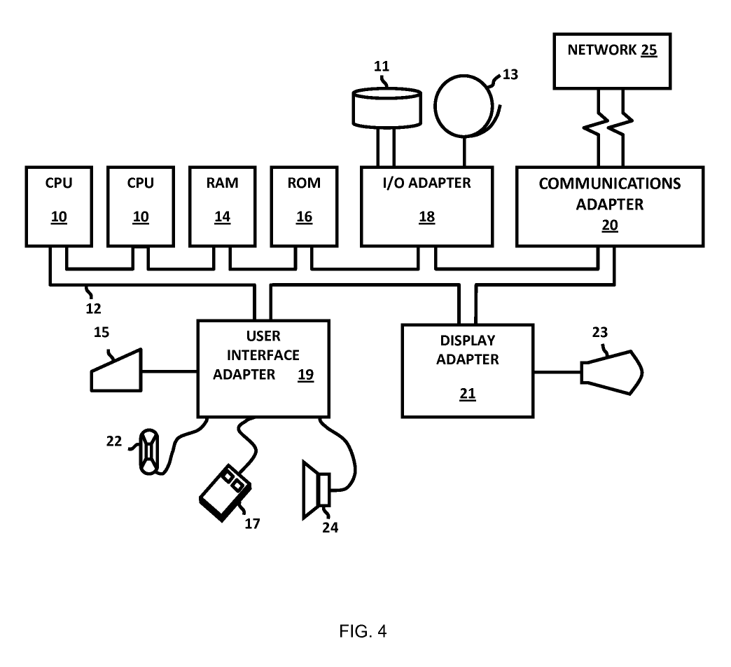

FIG. 2 is a flow diagram illustrating a method 200 for displaying electronic messages according to an embodiment of the invention. The electronic messages are displayed to a user in a conversation thread 210. FIG. 3 illustrates a system for displaying electronic messages according to an embodiment of the invention, wherein a display 310 is connected to an interface 320. In at least one embodiment, the display 310 is on or directly connected to a personal computer, laptop computer, telephone, personal digital assistant (PDA), and/or electronic tablet. The interface 320 is a mouse, keyboard, touchpad, and/or keypad.

The interface 320 receives a request from the user to display select messages from the conversation thread 220. In at least one embodiment, the request includes a request to display only messages sent from a select sender (e.g., show only messages from Sender X) or a request to display only messages not sent from the select sender (e.g., hide messages from Sender X). In another embodiment, the “select sender” includes a group of senders, e.g., all senders in Group B and/or all senders having the @uspto.gov domain name.

The groups of senders are predefined by the user and received as input via the interface 320. For example, when adding a new sender to her contact list, the user can categorize the new sender into a group (e.g., “Vendor”). In another example, the user can create a new group of senders and select any number of senders to add to the group. In at least one embodiment, a single sender is categorized into multiple groups (e.g., john.doe@ibm.com is categorized into the “Work”, “School”, and “Church” groups).

In at least one embodiment of the invention, the display 310 automatically displays options to the user in response to the user selecting a single message in the conversation thread. The single message can be selected by highlighting the single message with at least one key stroke (up arrow key, down arrow key, left arrow key, right arrow key, Page Up key, Page Down key, Home key, End key, U key, T key, D key, and/or B key); or, the single message is selected by positioning a cursor proximate (e.g., over, on, or next to) the single message.

In at least one embodiment, the options are automatically displayed to the user when the cursor is positioned proximate the single message (e.g., via a pop up window). Thus, the user can select an option with a single mouse click (within the pop up window); and, the request to display select messages includes only a single mouse click from the user. In another embodiment, the options are automatically displayed to the user when the cursor is positioned proximate the single message followed by an additional user interaction (e.g., right mouse button click).

Because options are automatically displayed to the user, the request to display select messages is received without the user having to manually enter text or type a search term. For example, the user is not required to filter e-mail messages by navigating through an e-mail client's search tool and manually typing a search term; instead, the user can select an option to display or hide a sender with one or two mouse clicks. Moreover, because the options are automatically presented to the user upon selection of a single message, the user is not required to navigate through the numerous options and sub-options within an e-mail client's search tool in order to locate options for filtering e-mail messages.

The interface 320 receives the user's selection, which is sent to a processor 330 as input. The processor 330 outputs to the display 310 the options to be presented to the user. The options that are automatically presented to the user include an option to display only messages sent from the sender of the single message and an option to display only messages not sent from the sender of the single message. In another embodiment, the options also include an option to display only messages sent from senders in a predefined group (wherein the predefined group includes the sender of the single message selected by the user) and an option to display only messages not sent from the senders in the predefined group.

For example, the user selects the sender john.doe@ibm.com by positioning the cursor over a message sent by john.doe@ibm.com, who the user has previously categorized into Group C. The selected sender is received by the processor 330 as input; and, the processor 330 sends options to the display 310 as output. The display 310 presents the user with options in a pop up window next to the cursor, including: “Show only e-mails from john.doe@ibm.com”; “Hide all e-mails from john.doe @ibm.com”; “Show only e-mails from @ibm.com”; “Hide all e-mails from @ibm.com”; “Show only e-mails from Group C”; and/or, “Hide all e-mails from Group C”. An updated conversation thread is displayed to the user based on the selected option.

In another embodiment of the invention, the request to display select messages from the user includes a first series of keystrokes from the user requesting display of only messages sent from the select sender (e.g., show only messages from Group D), or a second series of keystrokes from the user requesting display of only messages not sent from the select sender (e.g., hide all messages from Group D).

In yet another embodiment, the request to display the select messages from the user includes a filter term. The filter term is used to search numerous fields, including the name of the sender (e.g., first and/or last name, initials, user ID, nickname, handle), the e-mail address of the sender, and/or domain name of the sender (e.g., @us.ibm.com, @uspto.gov). The filter term can include stemming and/or wildcards. Thus, for example, the conversation thread is filtered to display only sender names beginning with “WIL”, such that senders named Will, William, Willard, Wilmer, and Wilma are displayed. In another example, the conversation thread is filtered to display only sender names that include “LIS”, such that senders named Lisa, Allison, Alissa, and Ellis are displayed.

Following receipt of the request from the user, the processor 310 sends an updated conversation thread to the display 310. The display 310 only displays the select messages to the user in the updated conversation thread 230 (based on the received request). For example, the updated conversation thread only includes messages sent from the select sender (e.g., only show messages from senders having the domain @uspto.gov), or only messages not sent from the select sender (e.g., all messages from senders having the domain @uspto.gov are hidden).

In at least one embodiment, the interface 310 receives a second request to display only messages sent from at least one second select sender, or to display only messages not sent from the at least one second select sender. Thus, for example, after receiving a first request from the user to only show messages from senders having the domain ibm.com in the updated conversation thread, a second request is received to only show messages within the updated conversation thread that are sent from senders in Group A (i.e., only show messages from senders having the domain ibm.com and senders in Group A). A second updated conversation thread is displayed to the user based on the second request, which includes: only messages sent from the select sender and messages sent from the second select sender (e.g., show messages from senders in Group E named “Jason”); only messages sent from the select sender and messages not sent from the second select sender (e.g., show messages from @uspto.gov, but not Group M (e.g., biotechnology)); only messages not sent from the select sender and messages not sent from the second select sender (e.g., hide messages from senders in Group AA and hide messages from senders having a name that begin with CHRIS); or only messages not sent from the select sender and messages sent from the second select sender (e.g., hide messages from Robert@ibm.com, but show all other senders with the @ibm.com domain). In another embodiment, more than one request to display select messages are received following the first request to display select messages from the user, such that the conversation thread is filtered/updated multiple times.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 4, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of displaying electronic messages, said method including:
displaying the electronic messages to a user in a conversation thread, the conversation thread only including a first message and at least one reply message, the reply message including at least one of a direct reply to the first message and an indirect reply to the first message;
receiving a request from the user to display select messages from the conversation thread, the request including one of:
a request to display only messages from the conversation thread sent from a select sender, and
a request to display only messages from the conversation thread not sent from the select sender; and
displaying only the select messages from the conversation thread to the user based on the received request, the select messages including one of:
only messages from the conversation thread sent from the select sender, and
only messages from the conversation thread not sent from the select sender.

2. The method according to claim 1, wherein said select sender includes a group of senders predefined by the user.

3. The method according to claim 1, further including, in response to the user selecting a single message in the conversation thread, automatically displaying at least one of:
an option to display only messages from the conversation thread sent from a sender of the single message, and
an option to display only messages from the conversation thread not sent from the sender of the single message.

4. The method according to claim 3, further including, in response to the user selecting the single message in the conversation thread, displaying at least one of:
an option to display only messages from the conversation thread sent from senders in a predefined group, the predefined group including the sender of the single message, and
an option to display only messages from the conversation thread not sent from the senders in the predefined group.

5. The method according to claim 4, wherein said displaying of the select messages to the user includes displaying one of:
only messages from the conversation thread sent from the sender of the single message;
only messages from the conversation thread not sent from the sender of the single message;
only messages from the conversation thread sent from the senders in the predefined group; and
only messages from the conversation thread not sent from the senders in the predefined group.

6. The method according to claim 1, wherein said receiving of the request includes receiving only a single mouse click from the user.

7. A method of displaying electronic messages, said method including:
displaying the electronic messages to a user in a conversation thread;
automatically displaying options to the user in response to the user selecting a single message in the conversation thread, the options including:
display only messages sent from a sender of the single message, and
display only messages not sent from the sender of the single message;
receiving a selected option from the user; and
displaying an updated conversation thread to the user based on the selected option.

8. The method according to claim 7, wherein the single message is selected by one of:
positioning a cursor proximate the single message, and
highlighting the single message with at least one key stroke.

9. The method according to claim 7, wherein the options further include:
displaying only messages sent from senders in a predefined group, the predefined group including the sender of the single message, and
displaying only messages not sent from the senders in the predefined group.

10. The method according to claim 9, wherein the updated conversation thread includes one of:
only messages sent from the sender of the single message;
only messages not sent from the sender of the single message;
only messages sent from the senders in the predefined group; and
only messages not sent from the senders in the predefined group.

11. The method according to claim 7, wherein said receiving of the selected option from the user includes receiving only a single mouse click from the user.

12. The method according to claim 7, wherein said receiving of the selected option from the user includes receiving one of:
a first series of keystrokes from the user requesting display of only messages sent from the sender of the single message, and
a second series of keystrokes from the user requesting display of only messages not sent from the sender of the single message.

13. The method according to claim 9, wherein said receiving of the selected option from the user includes receiving one of:
a third series of keystrokes from the user requesting display of only messages sent from the senders in the predefined group; and
a fourth series of keystrokes from the user requesting display of only messages not sent from the senders in the predefined group.

14. A method of displaying electronic messages, said method including:
displaying the electronic messages to a user in a conversation thread;
receiving input from the user, the input including predefined groups of senders;
receiving a request from the user to display select messages from the conversation thread, the request including one of:
a request to display only messages sent from senders in a predefined group, and
a request to display only messages not sent from the senders in the predefined group; and
displaying only the select messages to the user based on the received request, the select messages including one of:
only messages sent from the senders in the predefined group, and
only messages not sent from the senders in the predefined group.

15. The method according to claim 14, wherein said receiving of the request from the user includes receiving only a single mouse click from the user.

16. The method according to claim 14, wherein said receiving of the request from the user includes receiving one of:
a first series of keystrokes from the user requesting display of only messages sent from the senders in the predefined group, and
a second series of keystrokes from the user requesting display of only messages not sent from the senders in the predefined group.

17. The method according to claim 14, further including, in response to the user selecting a single message in the conversation thread, displaying at least one of:
an option to display only messages sent from the senders in the predefined group, the predefined group including the sender of the single message in the conversation thread, and
an option to display only messages not sent from the senders in the predefined group.

18. The method according to claim 17, wherein the single message is selected by one of:
positioning a cursor proximate the single message, and
highlighting the single message with at least one key stroke.

19. A system for displaying electronic messages, said system including:
a display for displaying the electronic messages to a user in a conversation thread and for displaying options to the user in response to the user selecting a single message in the conversation thread, the options including:
display only messages sent from a sender of the single message, and
display only messages not sent from the sender of the single message;
an interface for receiving a selected option from the user; and
a processor for sending an updated conversation thread to said display, the updated conversation thread being based on the selected option.

20. A computer program product for displaying electronic messages, said computer program product including:
a computer readable storage medium;
first program instructions to display the electronic messages to a user in a conversation thread;
second program instructions to display options to the user in response to the user selecting a single message in the conversation thread, the options including:
display only messages sent from a sender of the single message, and
display only messages not sent from the sender of the single message;
third program instructions to receive a selected option from the user; and
fourth program instructions to display an updated conversation thread to the user based on the selected option,
said first program instructions, said second program instructions, said third program instructions, and said fourth program instructions are stored on said computer readable storage medium.
